(19) United States
(12) Patent Application Publication
(10) Pub. No.: US 2013/0124358 A1
(43) Pub. Date: May 16, 2013

(54) Method to Create a Secondary Market (Exchange) Using a Web Auction to Price Annuity Payments

(71) Applicant: Stephen P. PARKER, Piedmont, CA (US)

(72) Inventor: Stephen P. PARKER, Piedmont, CA (US)

(21) Appl. No.: 13/420,960

(22) Filed: Mar. 15, 2012

Related U.S. Application Data
(60) Provisional application No. 61/560,628, filed on Nov. 16, 2011.

(51) Int. Cl. G06Q 30/08

(52) U.S. Cl. 705/26.3

(57) ABSTRACT

The method to create a secondary market using a web auction to price annuity payments comprises of an initial owner, a payor, an entity, an intermediary advisor, an annuity, and a lump sum of money. A plurality of payments is a fixed sum of money. The method also includes a method to create a wide area network, which comprises of a market price assessment module of web auction technology. The market price assessment module comprises of web auction technology comprises of a database module and a due diligence module. The due diligence module comprises of a buyer module, a seller module, and a bidding module. The buyer module comprises of the initial owner, the payor, and a source of funds. The seller module comprises of a copy of annuity, a credit report, an affidavit, and a uniform commercial code filing. The bidding module comprises of a reverse financial pricing engine.

The current application is a nonprovisional application and claims a priority to the U.S. provisional patent application Ser. No. 61/560,628 filed on Nov. 16, 2011.

### FIELD OF THE INVENTION

The present invention relates generally to a system and a method for an auction.

More specifically, the method and systems creates a secondary market, also known as an exchange to auction the payments of an annuity.

### BACKGROUND OF THE INVENTION

Individuals receive annuity payments for a number of reasons. These reasons can include but are not limited to lottery winnings, retirement plans, structured payment plans, or structured settlements. Often these individuals require a large sum of money at a later date and cannot finance their needs with the annuity payment. The individual must therefore trade the annuity payment for a lump sum payment. Several companies for instance, factoring companies, exist that can give the individual the lump sum payment in return for the annuity payment, including but not limited to J.G. Wentworth, Woodbridge Financial, Imperial Funding, etc. There are also independent companies, such as SettlementMarketPlace.com and Settlement Quote LLC, that purport to provide an individual multiple competitive bids from the established factoring companies, however, these bids are often not efficient, transparent or reflect market prices. Unfortunately, it is difficult for the seller of an annuity to know they are getting fair market value when they sell to these factoring companies and it is equally difficult for the factoring companies to later resell these annuities. It is especially difficult for factoring companies to sell these annuities to investors while still guaranteeing the stated annuity payments. If the annuity payment is sold and the underlying payment is not guaranteed, the annuity could be considered a security and subject to regulation by the United States Securities and Exchange Commission (SEC).

It is therefore an object of the present invention to provide a system and method to easily transfer rights to receive an annuity payment. It is a further object of the present invention to provide for the creation of a single asset trust in which a plurality of other users may be designated as beneficiaries to receive the annuity payments. It is a still further object of the present invention to provide an efficient marketplace (exchange) through the use of an online auction in which users may bid in real time for the right to receive the annuity payments. The annuities may be placed for auction as many times as desired and so the rights to receive the annuity payments may be transferred as many times as desired.

### BRIEF DESCRIPTION OF THE DRAWINGS

FIG. 1 is a flowchart of the present invention.

FIG. 2 is an illustration of a first step of the preferred embodiment of the present invention.

FIG. 3 is an illustration of a second step of the preferred embodiment of the present invention.

FIG. 4 is an illustration of a third step of the preferred embodiment of the present invention.

FIG. 5 is an illustration of a fourth step of the preferred embodiment of the present invention.

FIG. 6 is an illustration of a fifth step of the preferred embodiment of the present invention.

FIG. 7 is an illustration of a sixth step of the preferred embodiment of the present invention.

FIG. 8 is an illustration of a seventh step of the preferred embodiment of the present invention.

FIG. 9 is an illustration of an eighth step of the preferred embodiment of the present invention.

FIG. 10 is an illustration of a ninth step of the preferred embodiment of the present invention.

FIG. 11 is an illustration of a tenth step of the preferred embodiment of the present invention.

FIG. 12 is an illustration showing an example amount that an initial owner could receive from transferring an annuity.

FIG. 13 is a flowchart of the preferred embodiment of the present invention.

FIG. 14 is a flowchart showing the creation of a single asset trust.

FIG. 15 is a flowchart of a database module of the preferred embodiment of the present invention.

FIG. 16 is a flowchart of a due diligence module of the preferred embodiment of the present invention.

FIG. 17 is an alternative flowchart of the due diligence module of the preferred embodiment of the present invention.

### DETAIL DESCRIPTIONS OF THE INVENTION

All illustrations of the drawings are for the purpose of describing selected versions of the present invention and are not intended to limit the scope of the present invention.

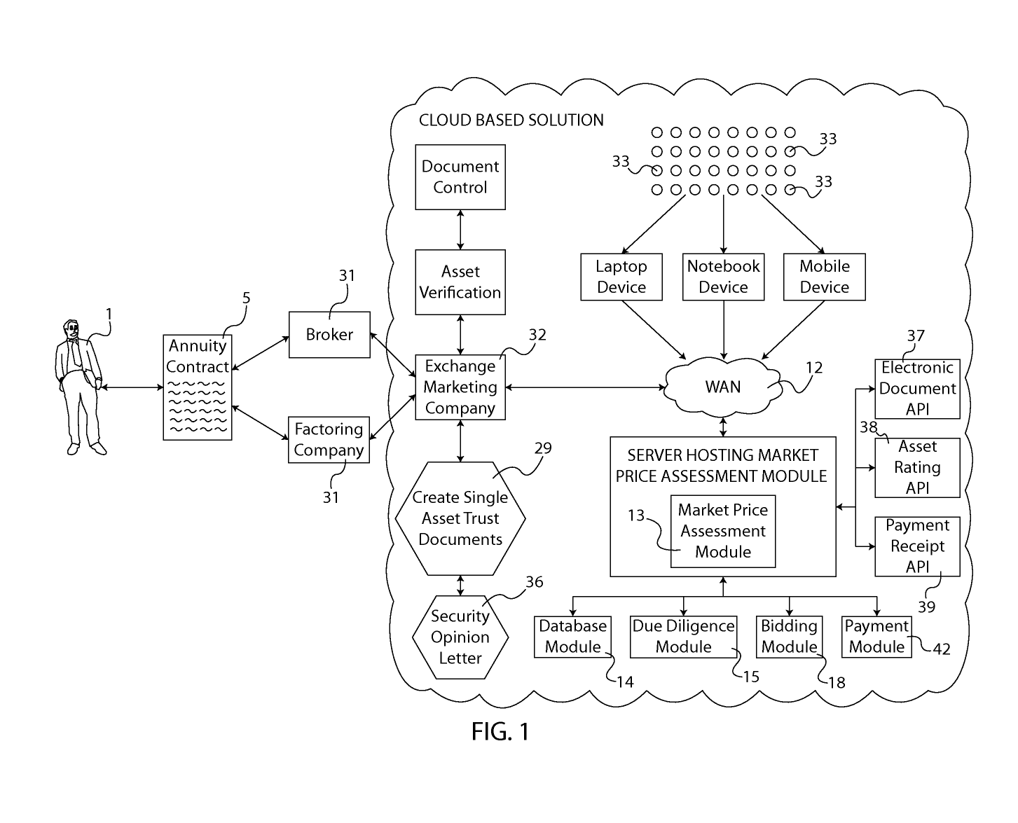

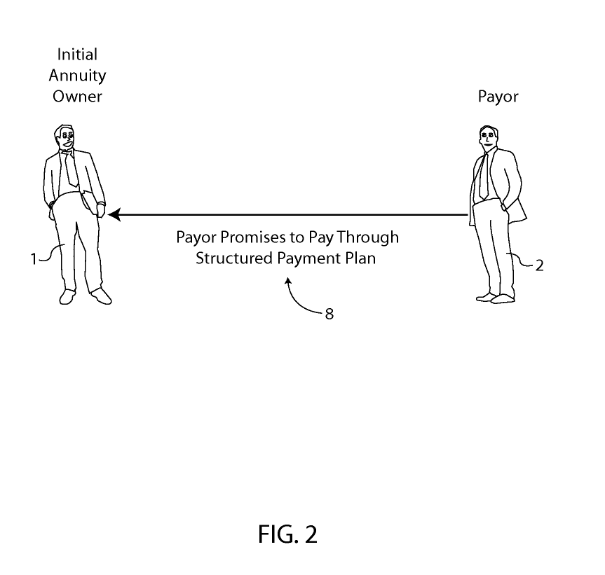

In reference to FIG. 1 and FIG. 2, the present invention is a system and method for auctioning annuities. This is accomplished through the creation of a secondary market (exchange) of a plurality of buyers and a plurality of sellers. The present invention comprises the sale of any kind of financial instrument that comprises an asset with an extended stream of payments, including but not limited to an annuity 5, a structured payment 8, or a lottery winning. Hereinafter, the term “annuity” refers to any such financial instrument used for the present invention.

Components of the present invention also include a web auction technology 27, a reverse financial pricing engine 28, and a proprietary trust document 9 to transfer the annuity 5 between the buyers and the sellers. In the preferred embodiment of the present invention, the annuity is resold without creating an SEC-regulated security. The secondary market (exchange) finds a market value of the annuity 5 and, with the proprietary trust document 9, allows the same annuity 5 to be resold again and again.

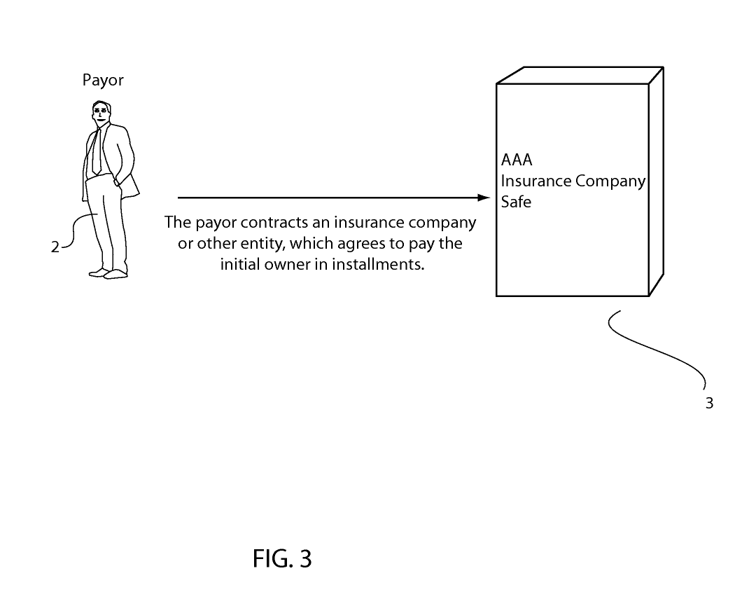

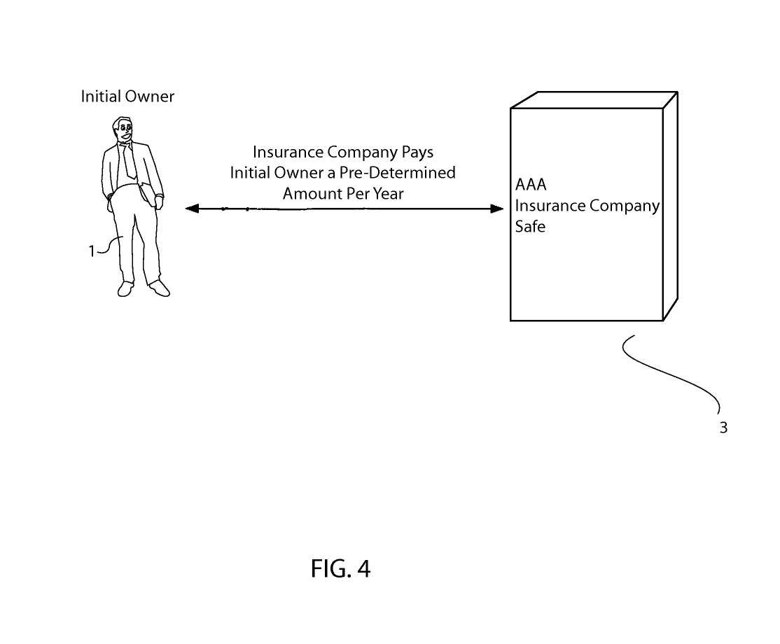

In the preferred embodiment, the present invention comprises the following steps: In reference to FIG. 1, FIG. 2 and FIG. 3, a payor 2 promises to pay an initial owner 1 of the annuity 5 through the structured payment plan 8 or other annuity. Then, the payor 2 contacts an entity 3, herein referred to as an insurance company 3, who agrees to pay the initial owner in installments in exchange for money from the payor 2. Other companies can be used as the entity 3 as well. The payor 2 may be obliged to pay the initial owner 1 of the annuity for any reason. For example, the initial owner 1 may be a lottery ticket buyer and the payor 2 is a lottery that must pay out lottery winnings to the initial owner 1. The initial owner 1 may be a retiree who is due an annuity for a retirement plan including but not limited to a pension. Also, the initial owner 1 may be a business owner receiving a structured payment. In reference to FIG. 4, an insurance company 3 (or other entity) pays the initial owner a pre-determined amount of money per a pre-determined period of time. The initial owner 1 is any individual who owns a right to the payments from the payor 2. The initial owner 1 may even be an entity with a plurality of owners.

The insurance company 3 is any entity that agrees to make the predetermined payment at the predetermined time to the initial owner 1. In most embodiments, the payment is a fixed sum of money per year, although alternative payment arrangements may also be used. The initial owner 1 receives annuity payments from the insurance company or other entity 3.

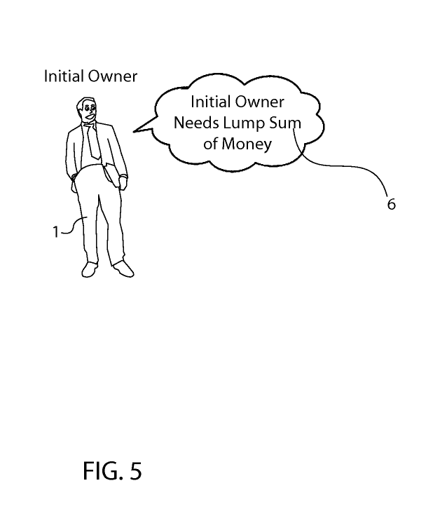

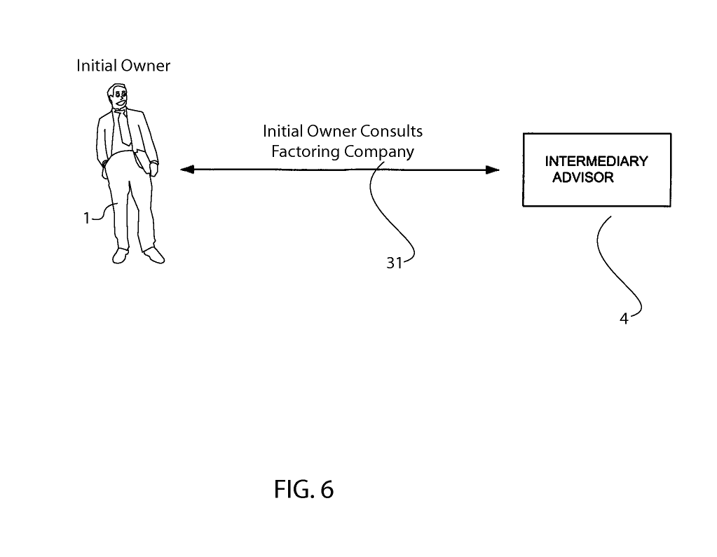

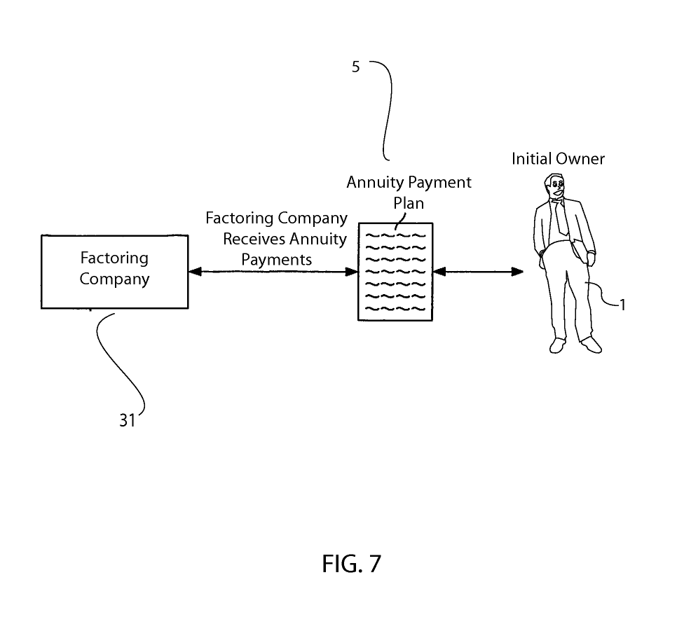

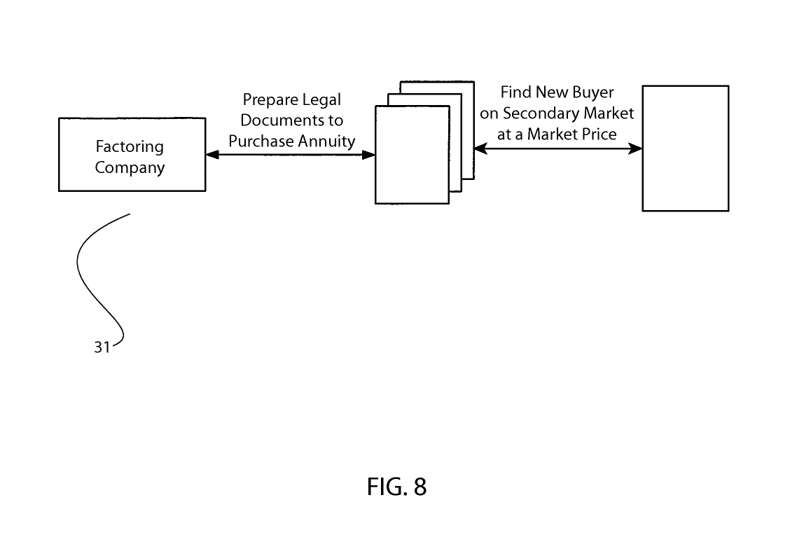

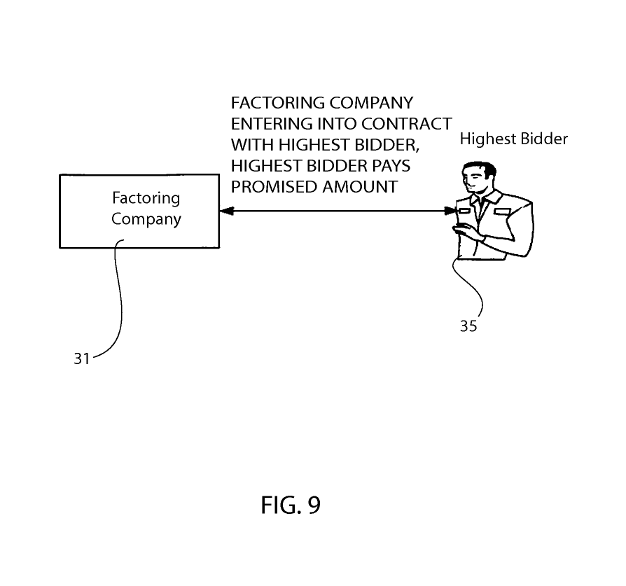

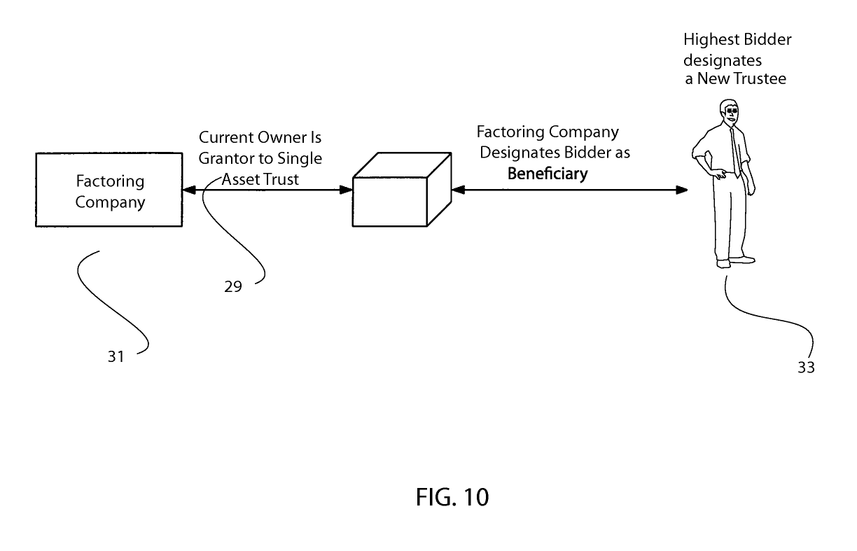

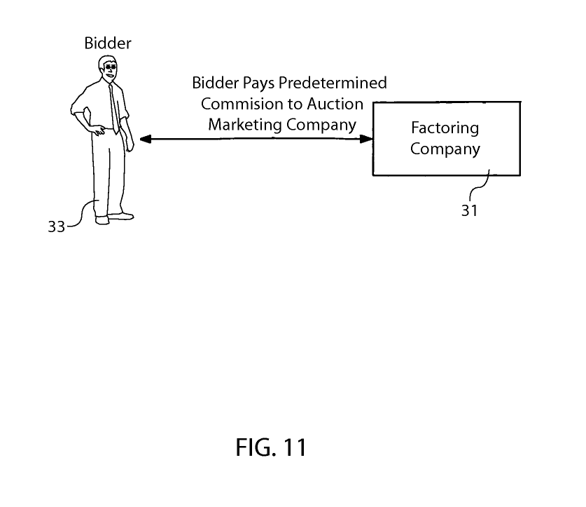

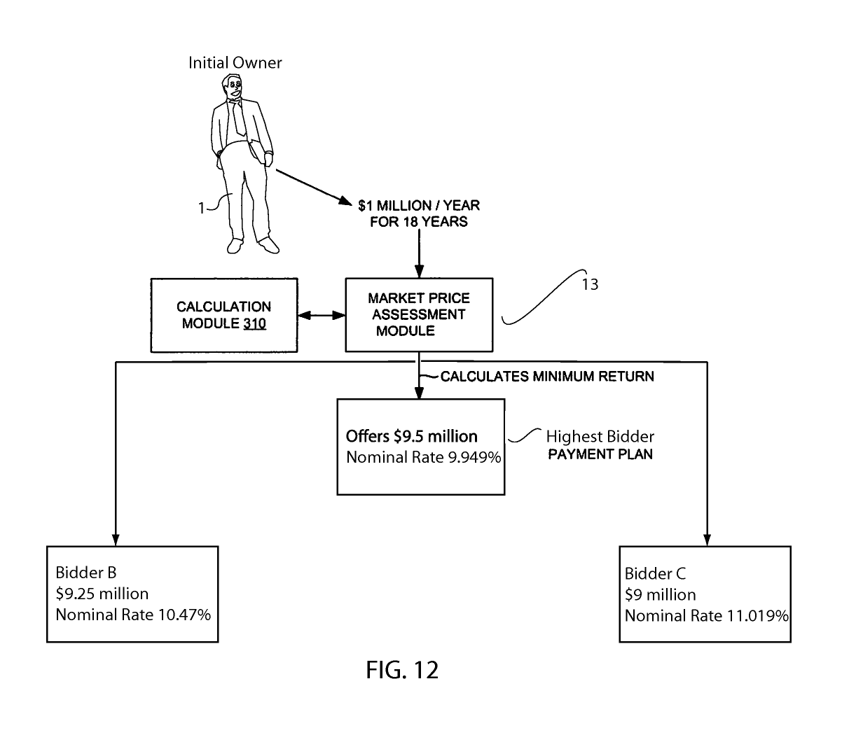

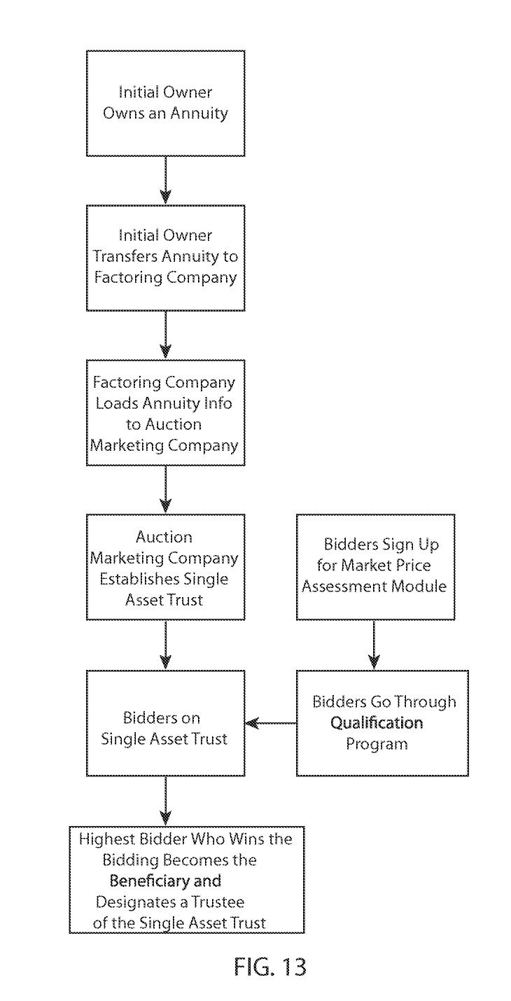

In reference to FIG. 1, FIG. 5, FIG. 6, FIG. 7, FIG. 8, FIG. 9, FIG. 10, FIG. 11, FIG. 12, and FIG. 13, the initial owner 1 needs a lump sum of money 6. When the initial owner 1 needs the lump sum 6 payment, the initial owner 1 must go to a new entity or intermediate advisor 4 to procure the lump sum 6 payment. In the preferred embodiment of the present invention, the initial owner 1 goes to a factoring company 4, although any intermediate advisor 4 that can offer a lump sum 6 payment in exchange for rights to the annuity payments may be used. Then, the exchange marketing company 32 agrees to pay for annuity plan. Then, the factoring company 31, which could also be a broker, also finds a new buyer for the annuity 5 on the secondary market at an unknown market price. The factoring company 31 enters into a contract with a bidder 33 who agrees to pay the lump sum for the annuity. The initial owner 1 grants the annuity 5 to a trust 29 created by the proprietary trust document 9 and the factoring company 31 designates the bidder 33 as a beneficiary 11. The bidder 33 pays a predetermined commission to an exchange marketing company 32 that facilitates the transaction.

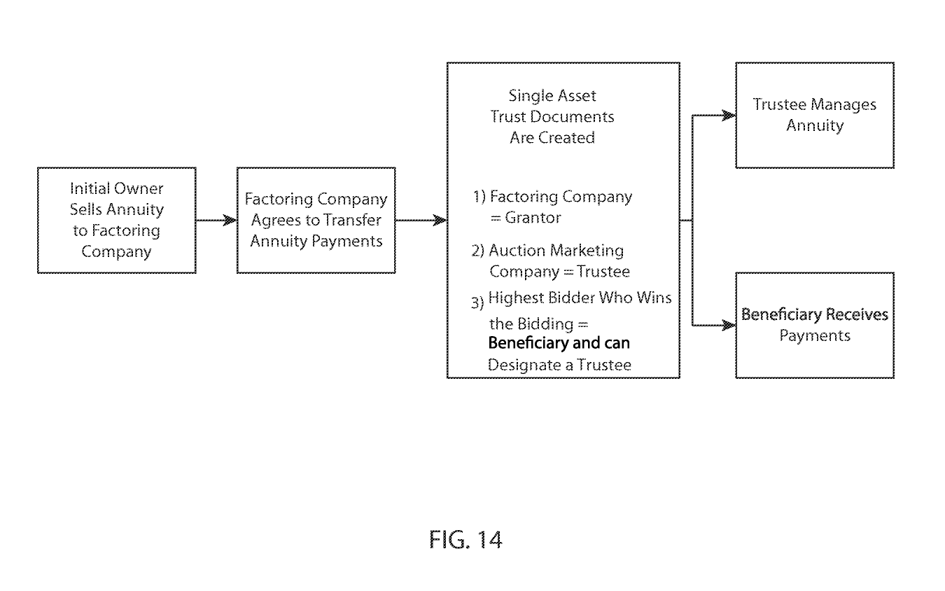

The factoring company 31 assesses the value of the annuity 5 using the web auction technology 27 of the present invention. The web auction technology 27 allows the factoring company 4 to determine the market price of the annuity 5. In reference to FIG. 13, in the process of utilizing the web auction technology 27, the factoring company 31 loads a plurality of information related to the annuity 5 to the exchange marketing company 32. Then, the factoring company 31 agrees to do business with the exchange marketing company 32. In reference to FIG. 14, the factoring company 4 first agrees to transfer the annuity payments to a new recipient. The factoring company 4 must load all of the annuity information to the exchange marketing company 32.

The exchange marketing company 32 establishes a single asset trust 29 comprising the annuity 5 and creates the proprietary trust document 9. Still in reference to FIG. 14, once the exchange marketing company 32 has all the annuity information, the exchange marketing company 32 can create the single asset trust 29, which created by using a copyrighted proprietary trust document 9. The single asset trust 29 comprises three parties: a grantor 30, a trustee 10, and a beneficiary and designated trustee 11. The grantor 30 is the party receiving the annuity payments, grants the annuity payments into the single asset trust on behalf of the beneficiary 11. The trustee 10 is the party that manages the single asset trust on behalf of the beneficiary 11 and distributes the annuity payments as directed by the beneficiary 11, who is the party that appoints the trustee 10. The annuity payment initially comes to the trustee 10 of the single asset trust 29, who then distributes the annuity payment to the beneficiary 11. The proprietary trust document 9 assigns the parties involved in the transfer of the annuity to the parties within the trust document 9. In the present embodiment, the grantor 30 is, but not limited to, the factoring company 31 and the trustee 10 is the exchange marketing company 32. In other embodiments, the grantor 30 can also be anyone who approaches the exchange marketing company 32. Also, in the preferred embodiment, the proprietary trust documents 9 further comprise a security opinion letter 36 from a securities attorney. The security opinion letter 36 from the securities attorney states that the securities attorney believes the single asset trust 29 to be a quality trust with a reasonable probability of making the annuity payments. The proprietary trust document 9 further comprises of additional information including but not limited to stipulations concerning how the single asset trust 29 may be transferred in the future, how beneficiaries may be changed, how to add or remove trustees, etc.

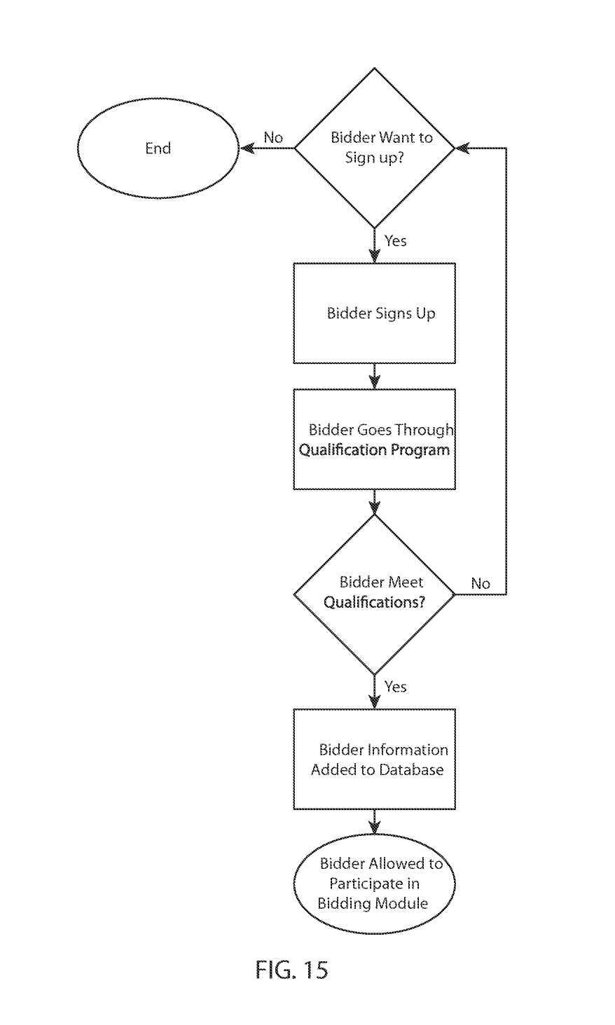

Referring to FIG. 13 and FIG. 15, a plurality of bidders 33 sign up to use a market price assessment module 13 for the web auction. Each bidder 33 goes through a qualification program 25. The bidder 33 may bid on the stream of payments paid to the single asset trust 29. The bidder 33 who wins the bidding process is entitled to receive the annuity payments.

In reference to FIG. 14, the highest bidder 35 who wins the bidding process is the new designated beneficiary 11 and appoints the new trustee. The exchange marketing company 32 acts as clearing agent and escrow to ensure transfer of the trust documents, annuity payments, and the settlement of funds between the winning bidder and the seller. In order for the exchange marketing company 32 to act as a clearing agent and escrow, the exchange marketing company 32 should have control of the trust documents and should verify the assets claimed in the single asset trust 29. In this way, because the annuity 5 is managed as a trust, the annuity payments are transferred without creating an SEC-regulated security.

In reference to FIG. 12, the exchange marketing company 32 places the single asset trust 29 information onto a server accessible by a wide area network (WAN) 12. The server 12 comprises of information on the single asset trust 29 and a market price assessment module 13. The plurality of bidders 33 can access the server through either a laptop device, a notebook device, or a mobile device. The interaction between the exchange marketing company 32 and the plurality of bidders 33 through the server allows the present invention to be a cloud based solution. In the preferred embodiment, the market price assessment module 13 is embedded onto a website managed by the exchange marketing company 32. The market price assessment module 13 further comprises a database module 14, a due diligence module 15, a bidding module 18, and a payment module 42.

The database module 14 comprises a database 24 and is used to manage customer relations. In reference to FIG. 15, to participate in the bidding in an online auction for the annuity payment on the server 12, each bidder 33 must sign up. Signing up creates a plurality of benefits to the bidder 33; including but not limited to an allowance to participate in auctions, an allowance to view information on single asset trusts 29, etc. When the bidder 33 signs up, the bidder 33 must pass the qualification program 25. The bidder 33 must meet a plurality of predetermined qualifications. If the bidder 33 does not meet the qualifications, the bidder 33 is not allowed to complete the sign up. In the preferred embodiment, the qualifications are meant to determine whether or not the bidder 33 is qualified to receive annuity payments and to perform due diligence on the bidder 33, although other qualifications may also be used to determine whether or not the bidder 33 may sign up. If the bidder 33 does meet the qualifications, the bidder 33 has a plurality of bidder information 26 added to the database 24. Once the bidder's 33 information 26 is added to the database 24, the bidder 33 is allowed to participate in the bidding module 18.

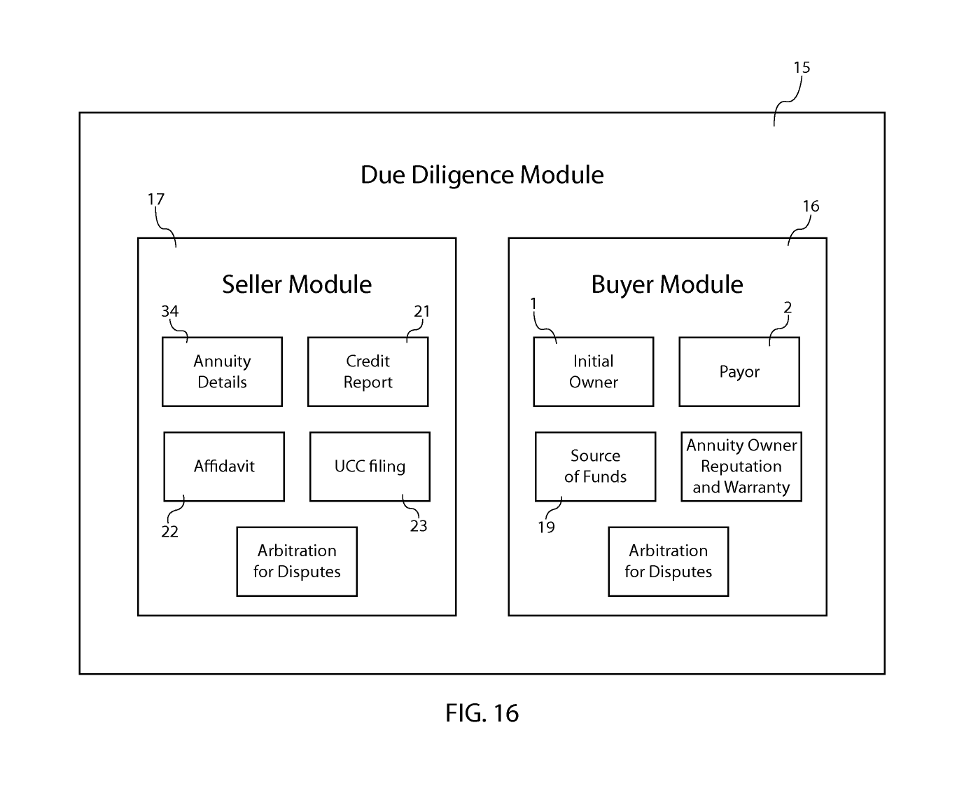

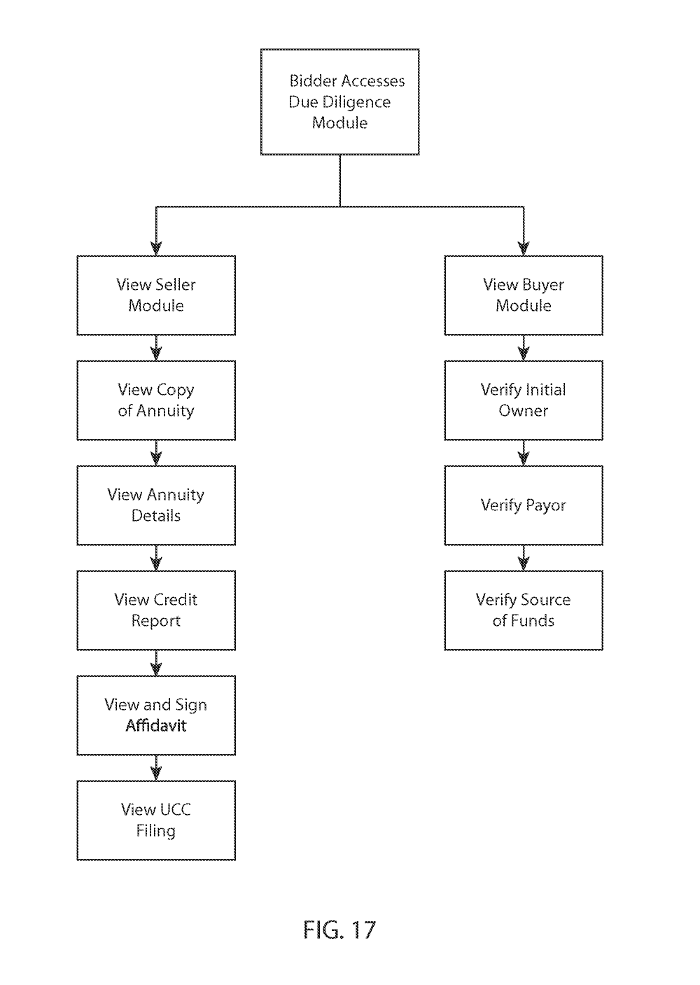

In reference to FIG. 16 and FIG. 17, the due diligence module 15 comprises a seller module 17 and a buyer module 16. The seller module 17 comprises a plurality of data concerning the seller of the annuity 5. The buyer module 16 comprises a plurality of data verifying the security of the annuity 5. The seller module 17 further comprises a plurality of annuity details 34, a credit report 21, an affidavit 22, and a Uniform Commercial Code (UCC) filing 23. Also, the seller module 17 allows the bidder 33 to obtain information concerning the trust 29 and the annuity payments and determine the quality of the underlying documents. The buyer module 16 further comprises information on the initial owner 1 of the annuity 5, the payor 2, and the insurance company or other entity 3 from which funds are provided to the initial owner 1. Also, the buyer module 16 allows the bidder 33 to verify the security of the initial owner 1, the payor 2, and the insurance company or other entity 3 so that the bidder 33 can have confidence that the stated annuity payment will be paid. In alternative embodiments of the present invention, additional information may be obtained in the due diligence module 15 and the bidder 33 may use the due diligence module 15 for other purposes as well. In addition, the due diligence module 15 allows the factoring company 31 and the beneficiary 11 to sign an arbitration for disputes document 40 and allows the factoring company 31 to sign an annuity owner reputation and warranty document 41. The arbitration for disputes document 40 absolves the exchange marketing company 32 from any disagreements between the factoring company 31 and the beneficiary 11. The annuity owner reputation and warranty document 41 assures the beneficiary 11 that the single asset trust 29 is authentic.

In reference to FIG. 13 and FIG. 14, the bidding module 18 allows the bidders 33 to bid for the right to become the beneficiary 11 and thus receive the annuity payments. In the bidding module 18, the online auction is performed. In the preferred embodiment, the bidder 33 bids to pay a lump sum 6 payment in exchange for rights to the annuity payments. In addition, the auction is preferably a reverse financial pricing engine 28 in which the bidder 33 bid on an interest rate of the annuity 5 and the bidder 33 who wins the bidding process is the bidder 33 who is willing to accept the lowest interest rate. Finally, the payment module 42 is used by the beneficiary 11 to receive the required documents to prove their purchase of the single asset trust 29.

The market price assessment module 13 also allows the bidders 33 to access a number of applications, which include the electronic document application programming interface (API) 37, the asset rating API 38, and the payment receipt API 39. The electronic document API 37 allows the bidders 33 to electronically sign any necessary documents. The asset rating API 38 allows the bidder 33 to look up the rating for the insurance company 3 providing the installment payments for the annuity. The payment receipt API 39 provides the beneficiary 11 with a receipt once their purchasing funds has been received and certified by the exchange marketing company 32.

In the preferred embodiment, the bidding module 18 comprises a proprietary licensed software to reverse auction the annuity 5, although any suitable software to conduct the auction may be used. In addition, in the preferred embodiment, the pricing software is embedded into the website of the present invention.

Because the method of the present invention creates the single asset trust 29, the annuities may easily be put up for auction again to transfer the right to receive the annuity payment. The annuity payments may be transferred any number of times.

Although the invention has been explained in relation to its preferred embodiment, it is to be understood that many other possible modifications and variations can be made without departing from the spirit and scope of the invention as herein described.

1. A method to create a secondary market using a web auction to price annuity payments by executing computer-executable instructions stored on a nontransitory computer-readable medium, the method comprises the steps of:
receiving a plurality of annuity term payments for an annuity from an entity on behalf of a payor wherein the entity is an insurance; company and the plurality of payments is a fixed sum of money per year;
exchanging the annuity for a lump sum of money between an initial owner and an intermediary advisor wherein the annuity initially belongs to the initial owner;
posting information about the annuity on a web auction by the intermediary advisor;
assessing a market price of the annuity from the web auction by the exchange marketing company;
creating a single asset trust by the exchange marketing company;
bidding on the annuity in the web auction by a plurality of bidders in a predetermined time period;
storing a plurality of bids in the web auction;
closing the web auction when the predetermined time period is completed;
evaluating the plurality of bids to identify a highest bidder;
exchanging the annuity for the lump sum of money between the highest bidder and the intermediary advisor and transfer the annuity to the intermediary advisor;
providing a computer server to host the web auction on a wide area network;
the computer server comprising a database module and a due diligence module;
the due diligence module comprising a buyer module, a seller module, and a bidding module;
the buyer module comprising a source of funds;
the seller module comprising a copy of annuity, a credit report, an affidavit, and a uniform commercial code filing;
the bidding module comprising a reverse financial pricing engine;
the bidding module bidding on a plurality of interest rates for the annuity by the reverse financial pricing engine;
receiving a plurality of annuity payments by the grantor;
creating a proprietary trust document by a trustee wherein the trustee is the exchange marketing company and the proprietary trust document containing information regarding the transferring of the annuity;
distributing of the annuity payments by the trustee;
sending a plurality of payments to a beneficiary wherein the beneficiary is the bidder; and
designating the trustee by the beneficiary.

2. (canceled)

3. (canceled)

4. The method to create a secondary market using a web auction to price annuity payments by executing computer-executable instructions stored on a nontransitory computer-readable medium as claimed in claim 1 comprises,
storing plurality of information regarding the web auction in the database module;
the database module comprising a database;
the database comprising a qualifications program, a web auction, a plurality of bidder information;
receiving a plurality of introductory bidder information to sign up for the web auction from each bidder;
qualifying each bidder by meeting a plurality of qualifications described by the qualifications program;
adding a plurality of bidder information to the database;
storing the plurality of bids by each bidder in the bidding module; and
comparing the plurality of bids for a highest bid.

5. The method to create a secondary market using a web auction to price annuity payments by executing computer-executable instructions stored on a nontransitory computer-readable medium claimed in claim 1 comprises
viewing the copy of annuity by each bidder;
the copy of annuity comprising of a plurality of annuity details;
viewing the plurality of annuity details by each bidder;
viewing the credit report by each bidder;
viewing the affidavit by each bidder;
signing the affidavit by each bidder; and
viewing the uniform commercial code filing by each bidder.

6. (canceled)
